(19) United States
(12) Patent Application Publication
(10) Pub. No.: US 2013/0051812 A1
(43) Pub. Date: Feb. 28, 2013

(54) IMAGE FORMING APPARATUS

(71) Applicant: Tomomichi Kawashima, Numazu-shi (JP)

(72) Inventor: Tomomichi Kawashima, Numazu-shi (JP)

(73) Assignee: CANON KABUSHIKI KAISHA, Tokyo (JP)

(21) Appl. No.: 13/596,868

(22) Filed: Aug. 28, 2012

(30) Foreign Application Priority Data
Aug. 31, 2011 (JP) 2011-188961

(51) Int. Cl. G03G 15/00

(52) U.S. Cl. 399/12; 399/167

(57) ABSTRACT

In an image forming apparatus including a motor configured to drive a developing roller and an unsealing mechanism, and a motor configured to drive a photosensitive drum, a photosensitive drum is driven at a peripheral velocity higher than that at a time of image formation to aid rotation of the developing roller, during a period of opening a seal member by the unsealing mechanism.

### BACKGROUND OF THE INVENTION

1. Field of the Invention

The claimed invention generally relates to an electrophotographic image forming apparatus such as a copying machine or a printer equipped with a process cartridge detachable from the apparatus main body.

2. Description of the Related Art

Conventionally, an electrophotographic image forming apparatus has adopted a process cartridge system in which a photosensitive drum and a process unit acting on the photosensitive drum are integrally combined into a cartridge that is detachable from the image forming apparatus main body. In the process cartridge system, the operator himself can perform the maintenance of the apparatus without relying on a serviceman, which makes it possible to substantially improve operability. This is why the process cartridge system is widely employed for electrophotographic image forming apparatuses.

In order to apply toner to an electrostatic latent image formed on the photosensitive drum, the process cartridge employs a developing device. This developing device includes a developing roller configured to supply toner to the photosensitive drum, and a toner container storing toner and equipped with an opening for supplying toner to the developing roller.

Japanese Patent Application Laid-Open No. 9-146368 discusses a process cartridge in which an opening, when the process cartridge is still unused, i.e., new, is sealed by a sealing member so that no toner may leak through the opening of the toner container. One end of the sealing member is fixed to a take-up member, which unseals a sealing member. When an unused, new process cartridge is attached to the image forming apparatus main body, the take-up member rotates to take up the sealing member so that the sealing member of the opening is peeled off, thus automatically unsealing the process cartridge. The drive device for operating the take-up member must be selected taking into account the temporary load torque employed when taking up the sealing member.

Japanese Patent Application Laid-Open No. 2005-077742 discusses a construction in which the drive device for operating a stirring member for stirring the toner in the toner container also serves as the drive device for operating the take-up member. In this construction, the leveling-off of the load torque is achieved through deviation in drive timing between the stirring member and the take-up member, thus suppressing build-up in the specs of the drive device.

However, in Japanese Patent Application Laid-Open No. 9-146368, the operation of the stirring member is delayed as compared with opening timing of the sealing member by the unsealing mechanism, so that it is necessary to provide a screw mechanism, resulting in an increase in the number of components and in a complicated device. Further, by delaying the operation of the stirring member, at the time of starting the use of the cartridge, the time until image formation increases, so that the user's waiting time can be increased.

### SUMMARY OF THE INVENTION

The claimed invention is directed to an image forming apparatus capable of unsealing the sealing member with a simple construction while suppressing an increase in the waiting time for the user when the use of the process cartridge is started.

According to an aspect of the claimed invention, an image forming apparatus includes: a process cartridge including an image bearing member for bearing an electrostatic latent image, a toner container for storing toner, a developer carrying member configured to rotate while in contact with the image bearing member to develop the electrostatic latent image with the toner, a sealing member configure to seal an opening provided in the toner container, and an unsealing mechanism configured to open the sealing member; a first drive device configured to drive the developer carrying member and the unsealing mechanism; a second drive device configured to drive the image bearing member; and a control unit configured to control the first drive device and the second drive device and to drive the image bearing member by the second drive device at a peripheral velocity higher than that at a time of image formation, during a period of opening the sealing member by the unsealing mechanism.

Further features and aspects of the claimed invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the claimed invention and, together with the description, serve to explain the principles of the claimed invention.

FIG. 1 is a main portion sectional view illustrating an image forming apparatus according to an exemplary embodiment to which the claimed invention is applicable.

FIG. 2 is a main portion sectional view illustrating a process cartridge according to an exemplary embodiment to which the claimed invention is applicable.

FIG. 3 is a main portion perspective view illustrating an image forming apparatus according to an exemplary embodiment to which the claimed invention is applicable.

FIG. 4 is a main portion perspective view illustrating an image forming apparatus according to an exemplary embodiment to which the claimed invention is applicable.

FIG. 5 is a flowchart illustrating processing operations according an exemplary embodiment to which the claimed invention is applicable.

FIG. 6 is a diagram illustrating a torque reduction effect of the claimed invention.

FIG. 7 is a main portion perspective view illustrating a process cartridge according to an exemplary embodiment to which the claimed invention is applicable.

FIG. 8 is a main portion perspective view illustrating a process cartridge according to an exemplary embodiment to which the claimed invention is applicable.

### DESCRIPTION OF THE EMBODIMENTS

Various exemplary embodiments, features, and aspects of the claimed invention will be described in detail below with reference to the drawings.

In the following, an exemplary embodiment according to the claimed invention will be described in detail with reference to the drawings. The dimensions, materials, configurations, and positional relationship of the components described in relation to this exemplary embodiment can be modified as appropriate according to the apparatus to which the claimed invention is applied and to various conditions, so that, unless otherwise specified, they are not construed as intended to restrict the scope of the claimed invention.

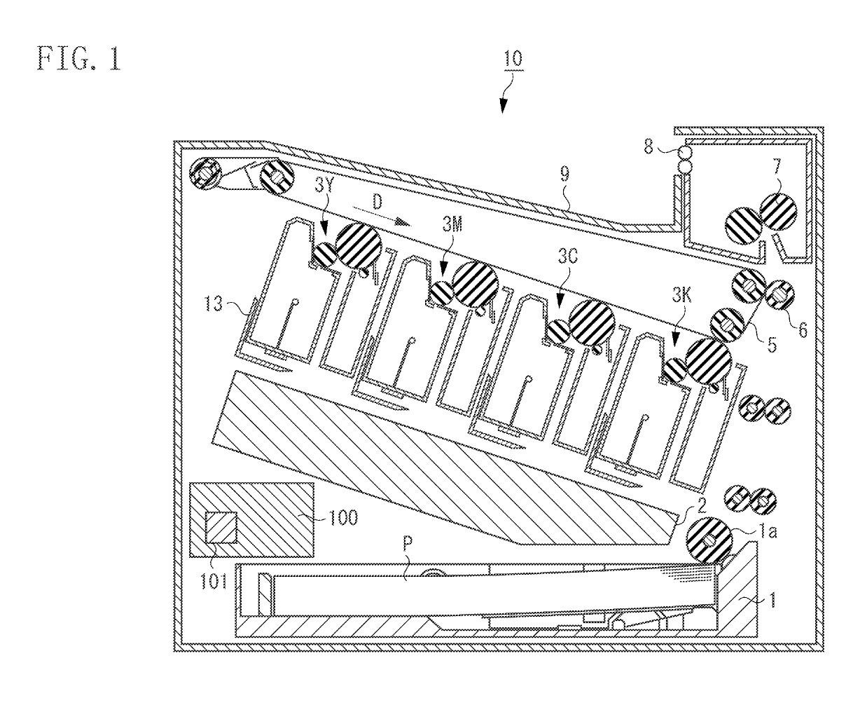

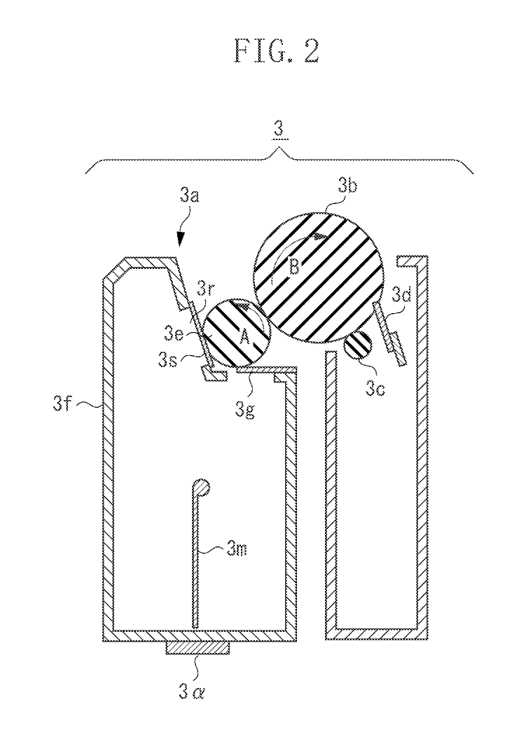

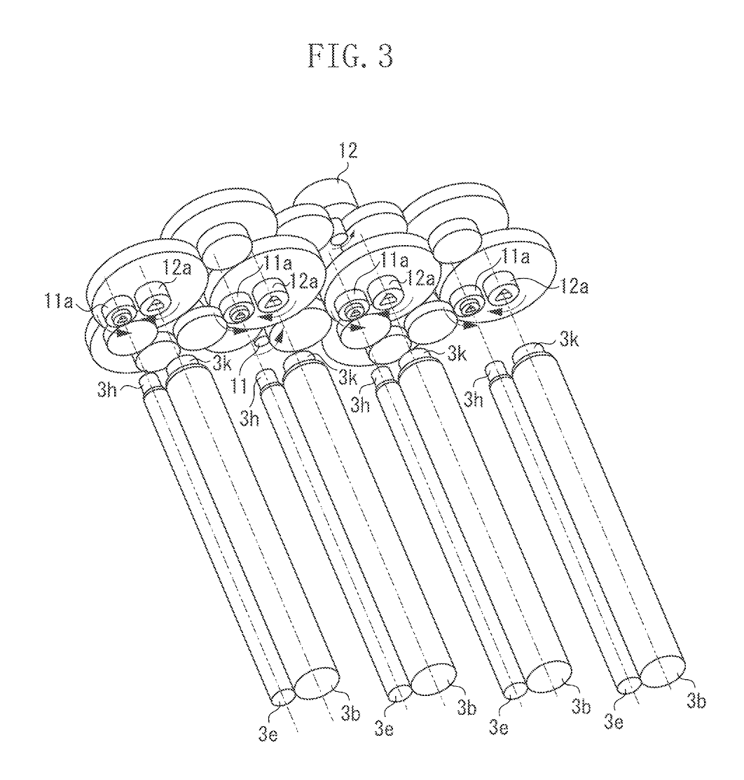

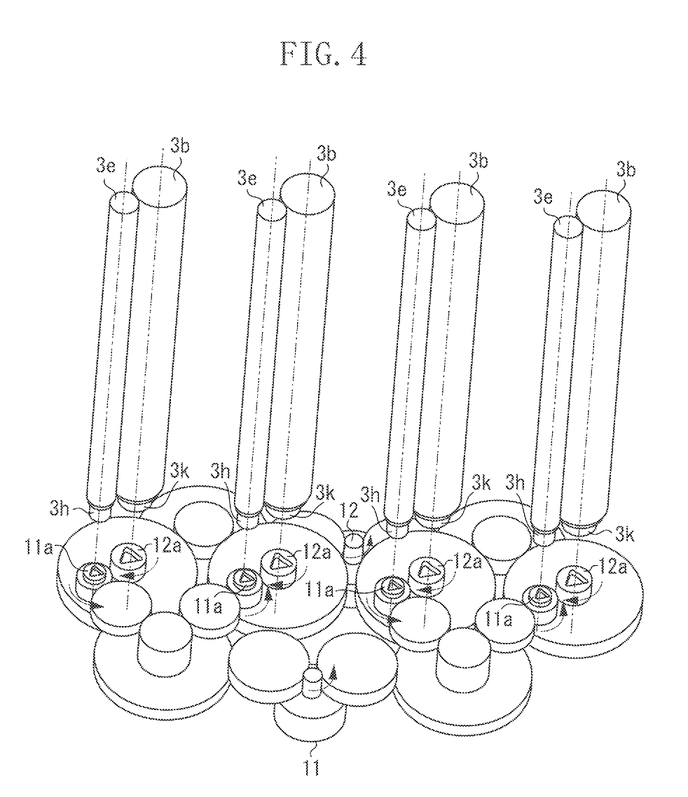

FIG. 1 is a sectional view schematically illustrating the construction of an image forming apparatus according to the present exemplary embodiment, and FIG. 2 is a sectional view schematically illustrating the construction of a process cartridge according to the present exemplary embodiment. FIGS. 3 and 4 are perspective views schematically illustrating the construction of the image forming apparatus according to the present exemplary embodiment.

The image processing apparatus is an apparatus configured to form a toner image by using toner as the developer based on image information input from the exterior by a known electrophotographic technique, transferring and fixing the toner image to a medium such as paper. Examples of the image processing apparatus include a laser beam printer and a facsimile apparatus. By way of example, the present exemplary embodiment will be described as applied to a color laser beam printer having a plurality of process cartridges in order to form a color image.

The process cartridge can be defined as a cartridge into which at least a developing device and an electrophotographic image bearing member (photosensitive drum) as process units are integrated and which is detachable from the main body of an image forming apparatus.

First, the construction and function of an image forming apparatus 10 will be described with reference to FIGS. 1 and 2. The image forming apparatus 10 includes a feeding device 1, an exposure unit 2, a process cartridge 3, an intermediate transfer member 5, a primary transfer unit (not illustrated), a secondary transfer unit 6, and a fixing unit 7.

A toner image formed on the surface of a photosensitive drum 3b (image bearing member) of the process cartridge 3 by a process unit described below is transferred to the surface of the intermediate transfer member 5 by the primary transfer unit (not illustrated). FIG. 1 illustrates a tandem type color image forming apparatus in which four process cartridges 3Y, 3M, 3C, and 3K are arranged in a straight line.

The four process cartridges 3Y, 3M, 3C, and 3K, which are of the same structure, respectively correspond to the four colors of yellow (Y), magenta (M), cyan (C), and black (K), and are configured to form toner images of the different colors on the intermediate transfer member 5 rotating in the direction of the arrow D so as to superimpose them one upon the other.

A medium P such as paper set in the feeding device 1 is fed to the secondary transfer unit 6 by a feeding roller 1a. The toner image formed on the intermediate transfer member 5 is transferred to the medium P by the secondary transfer unit 6, and is conveyed to the fixing unit 7, where the toner image is fixed to the medium P by heat and pressure. After this, the medium P is conveyed by a discharge roller pair 8a, 8b and is discharged onto a discharge tray 9 provided in the upper portion of the image forming apparatus 10.

As illustrated in FIGS. 3 and 4, the image forming apparatus 10 has a motor 11 (first drive device) and a motor 12 (second drive device) as the drive devices for operating the process cartridges 3Y, 3M, 3C, and 3K.

As illustrated in FIG. 1, the image forming apparatus 10 is provided with a control board 100 on which an electric circuit for controlling the main body of the image forming apparatus 10 is mounted. A central processing unit (CPU) 101 is mounted on the control board 100. The CPU 101 collectively controls the operation of the main body of the image forming apparatus 10, inclusive of the control of the motor 11 and the motor 12, which are the driving devices for the process cartridges 3. The CPU 101 performs wireless communication with non-contact-type non-volatile memory 3α (see FIG. 2) serving as a storage device mounted to the process cartridges 3, whereby it can write and read information to and from the non-contact-type non-volatile memory 3α as described below.

The main body of the image forming apparatus 10 is provided with an attachment portion 13 for detachably attaching the process cartridges 3.

Next, the construction and function of the process cartridges 3 detachably mounted to the image forming apparatus 10 will be described with reference to FIGS. 1 through 4. Each process cartridge 3 includes a developing device 3a, a photosensitive drum 3b, a charging roller 3c as a charging unit, and a cleaning blade 3d as a cleaning unit. The developing device 3a includes a developing roller 3e, a toner container 3f (developer container), a regulating member 3g, a stirring member 3m, and non-contact-type non-volatile memory 26.

The photosensitive drum 3b is provided so as to be rotatable. Arranged around the photosensitive drum 3b are the charging roller 3c, the developing roller 3e, and the cleaning blade 3d, each in contact with the photosensitive drum 3b (The developing roller 3e is arranged so as to press the photosensitive drum 3b through toner). The photosensitive drum 3b charged by the charging roller 3c is irradiated with a laser beam corresponding to image information from an exposure unit 2, whereby an electrostatic latent image is formed. This electrostatic latent image is developed with toner by the developing roller 3e arranged to be in contact with the photosensitive drum 3b, and is turned into a visible image, i.e., a toner image.

The cleaning blade 3d scrapes off the residual toner remaining on the photosensitive drum 3b after the toner image has been transferred to the intermediate transfer member 5 by the primary transfer unit (not illustrated), thus cleaning the surface of the photosensitive drum 3b.

The developing roller 3e is arranged at an opening 3r of the toner storing container 3f. The regulating member 3g is held in contact with the developing roller 3e, regulating the toner amount to carry a thin layer of toner on the developing roller 3e.

The stirring member 3m is arranged inside the toner storing container 3f, stirring the toner inside the toner storing container 3f to supply the same to the developing roller 3e.

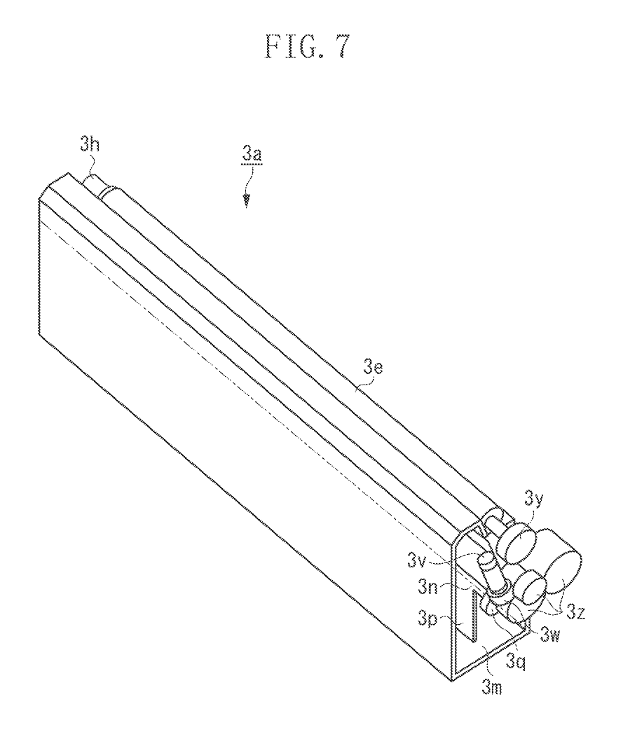

As illustrated in FIG. 7, the stirring member 3m includes a stirring shaft 3n, a stirring sheet 3p mounted to the stirring shaft 3n, and a stirring drive gear 3q provided at an end portion of the stirring shaft 3n.

As illustrated in FIGS. 3 and 4, a coupling 3h is provided at an end portion of the developing roller 3e. The coupling 3h is connected with a coupling 11a on the image forming apparatus 10 main body, whereby the drive force from the motor 11 of the image forming apparatus main body can be transmitted to the developing roller 3e. Further, a coupling 3k is provided at an end portion of the photosensitive drum 3b. The coupling 3k is connected with a coupling 12a on the image forming apparatus main body side, whereby the drive force from the motor 12 of the image forming apparatus main body can be transmitted to the photosensitive drum 3b.

Further, as illustrated in FIG. 7, a transmission gear 3y is fixed to the end portion of the developing roller 3e on the side opposite the side where the coupling 3h is provided. When the developing roller 3e rotates, the stirring drive gear 3q is rotated via a transmission gear 3Y and an idler gear 3z, thereby rotating the stirring member 3m.

As illustrated in FIG. 2, the toner container 3f has the opening 3r, which is provided for the purpose of supplying toner to the developing roller 3e. The stirring roller 3e rotates within the toner container 3f, whereby the toner is stirred and supplied to the developing roller 3e.

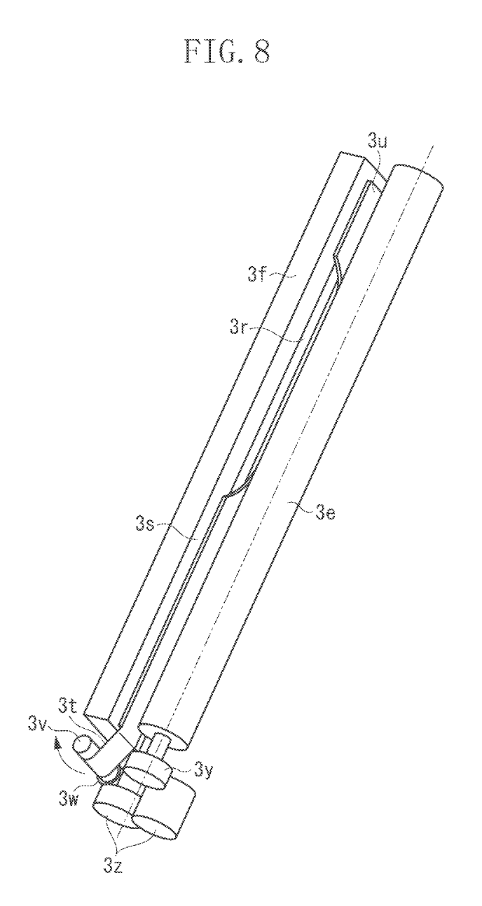

In order that no toner may leak during the transportation of the process cartridge 3, a seal member 3s is bonded to the periphery of the opening as illustrated in FIG. 8. In other words, the seal member 3s seals the opening 3r.

The seal member 3s has a portion bonded to the toner container 3f and a free end 3t not bonded thereto. Further, the seal member 3s has a folded-back portion 3u between the portion bonded to the toner container 3f and the free end 3t. The free end 3t of the seal member 3s is fixed to a take-up member 3v that is an unsealing mechanism for the seal member 3s. The take-up member 3v has at one end a take-up drive gear 3w, and the drive of the developing device 3e is transmitted to the drive gear 3w via the transmission gear 3Y and the idler gear 3z.

When the take-up member 3v is rotated, a force for peeling off the seal member 3s is applied to the folded-back portion 3u, and the seal member 3s is peeled off from the folded-back portion 3u side. After the seal member 3s has been peeled off from the opening 3r, the take-up ember 3v runs idle together with the taken up seal member 3s.

In this way, the developing roller 3e, the stirring member 3m, and the take-up member 3v are driven by the motor 11 of the image forming apparatus main body, and the photosensitive drum 3b is driven by the motor 12 of the image forming apparatus main body.

The non-contact-type non-volatile memory 3α stores information about whether the process cartridge 3 is new. The memory can wirelessly communicate with CPU 101 of the image forming apparatus via an antenna (not illustrated) as an information transmission unit with which the memory 3α is provided. When the process cartridge 3 is attached to the image forming apparatus main body, the CPU 101 reads and writes information stored in the memory 3α about whether the process cartridge is new. In this way, the memory 3α and the CPU 101 provided in the image forming apparatus main body function as a new product detection device.

The detection device is not restricted to the above-described one. It is also possible, for example, to provide the process cartridge with a fuse, through which an electric current passes after the attachment of a new process cartridge to the image forming apparatus main body, whereby the fuse ruptures, thus making it possible to determine whether the process cartridge is a new one according to an electric current which flows through the circuit including the fuse.

Next, the operation of the image forming apparatus 10 in normal developing processing (at the time of image formation) will be described. As illustrated in FIGS. 3 and 4, when the motor 11 of the main body of the image forming apparatus 10 rotates in the direction of the arrow, the coupling 11a rotates in the direction of the arrow via the idler gear. When the motor 12 rotates in the direction of the arrow, the coupling 12a rotates in the direction of the arrow via the idler gear.

In the state in which the process cartridge 3 is attached to the main body of the image forming apparatus 10, the coupling 11a of the image forming apparatus 10 main body configured to be rotated by the rotation of the motor 11, and the coupling 3h provided at an end portion of the developing roller 3e, are connected with each other. Further, the coupling 12a of the image forming apparatus 10 main body configured to be rotated by the rotation of the motor 12, and the coupling 3k provided at an end portion of the photosensitive drum 3b, are connected with each other. When the couplings are connected with each other, the developing roller 3e rotates in the direction of the arrow A in FIG. 2, and the photosensitive drum 3b rotates in the direction of the arrow B.

As described above, the photosensitive drum 3b and the developing roller 3e are rotating while in contact with each other. Assuming that the peripheral velocity of the photosensitive drum 3b during normal developing processing is Vb, and that the peripheral velocity of the developing roller 3e is Ve, the relationship regarding peripheral velocity is set to Vb<Ve, taking into account a case where an image of high density is processed. The revolutions per minute (RPM) of the motor 11 at this time is Re, and that of the motor 12 is Rb.

Next, the operation of the image forming apparatus 10 when a new (unused) process cartridge 3 is attached will be described. The seal member 3s of the new (unused) process cartridge 3 has not been unsealed yet. Thus, the torque used for driving the developing roller 3e is larger than a process cartridge which has already been in use, by an amount that the seal member 3s is taken up.

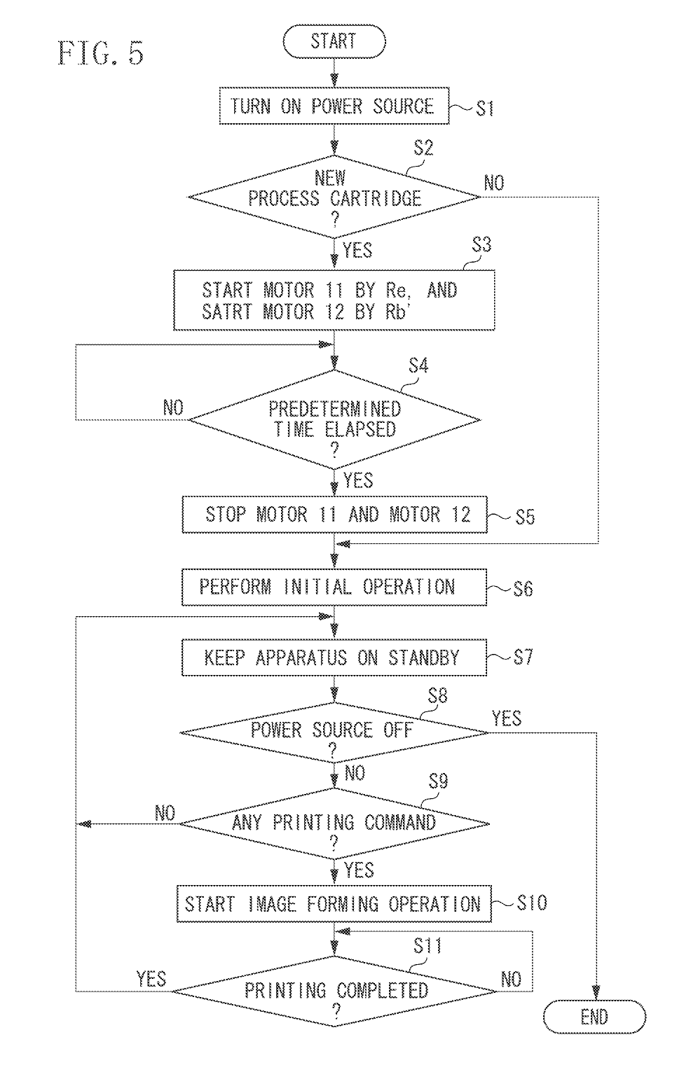

The operational flow according to the present exemplary embodiment will be described with reference to the flowchart of FIG. 5, and the operation when a new process cartridge 3 is attached to the image forming apparatus 10 will be described. The processing is conducted by the CPU 101.

When, in step S1, the power source of the main body is turned on, the CPU 101 reads, in step S2, the information of the memory 3α through wireless communication to determine whether the process cartridge 3 is new. When, in step S2, it is determined that the process cartridge 3 is new, the CPU 101 starts, in step S3, the motor 11 at the RPM Re, and starts the motor 12 at an RPM Rb′, which is larger than the RPM Rb used at the time of image formation. As a result, the photosensitive drum 3b rotates at a peripheral velocity Vb′, which is higher than the peripheral velocity Vb used at the time of image formation.

Through the rotation of the motor 11, drive is transmitted to the developing roller 3e and to the take-up member 3v, and an automatic unsealing operation for the seal member 3s is started. The developing roller 3e is driven at the peripheral velocity Ve, which is the same as that at the time of image formation. However, due to the rotation of the motor 12, the photosensitive drum 3b is rotating at the peripheral velocity Vb′, and since the rotation of the developing roller 3e is aided by the rotation of the photosensitive drum 3b, the load torque of the motor 11 is reduced.

When, in step S4, it is determined that a predetermined period of time has elapsed since the start of the motor 11 and of the motor 12, it is determined that the initial operation for placing the new process cartridge in a usable state has been completed. In step S5, the rotation of the motor 11 and of the motor 12 is stopped, thus completing the sequence for the new process cartridge 3. After this, in step S6, the main body of the image forming apparatus 10 performs the initial operation for accepting a print command, and, in step S7, it makes transition to a standby state. When, at this time, the power is not turned off in step S8, and a print command is given in step S9, image forming operation is started in step S10.

The RPM of the motor 11 and that of the motor 12 at this time cause the developing roller 3e and the photosensitive drum 3b to rotate at a peripheral velocity corresponding to normal developing process, i.e., Re and Rb, respectively. When, in step S11, the series of printing operations have been completed, the procedure returns to step S7, and the apparatus makes transition to a standby state again.

It is desirable that the above-mentioned predetermined period of time (the time involved for the CPU 101 to recognize that a new process cartridge 3 has been attached to the image forming apparatus 10 and rotate the motor 12 at the RPM Rb′) be not shorter than the time involved for the seal member 3s to be taken up by the take-up member 3v. In the present exemplary embodiment, the predetermined period of time is approximately 15 seconds.

In the present exemplary embodiment, it is possible to simultaneously perform the operation of the stirring member 3m and the take-up operation for the seal member 3s without shifting their operations. The waiting time for the user when using a new process cartridge is suppressed to approximately 15 seconds.

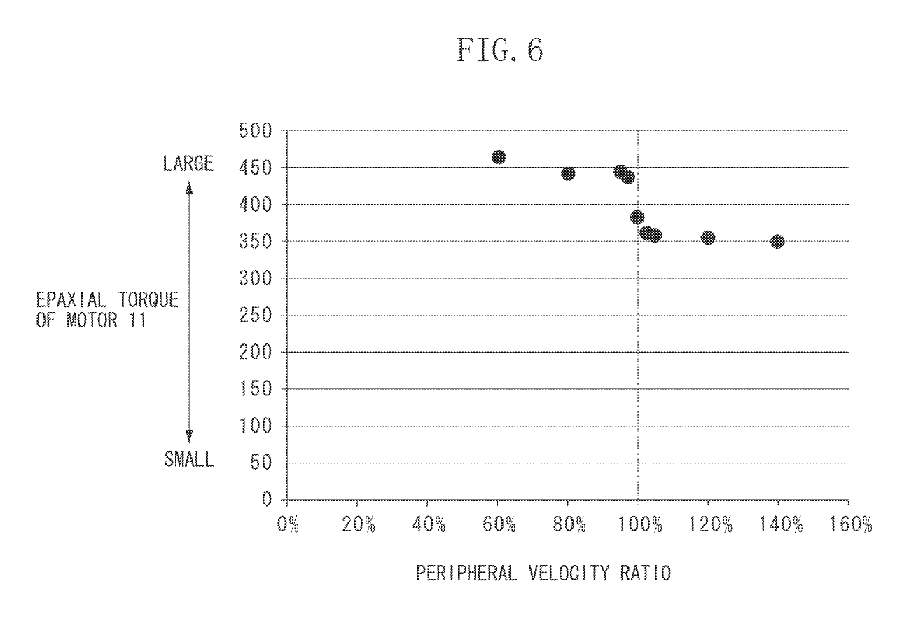

Referring to FIG. 6, the load torque reduction effect achieved by the present exemplary embodiment will be described. FIG. 6 illustrates changes in the torque used for driving the developing roller 3e when the peripheral velocity of the photosensitive drum 3b is varied, with the peripheral velocity of the developing roller 3e remaining constant. The horizontal axis indicates peripheral velocity ratio (the ratio of the peripheral velocity of the photosensitive drum 3d to the peripheral velocity of the developing roller 3e), and the vertical axis indicates the epaxial torque of the motor 11.

As can be seen from the diagram, the larger the peripheral velocity ratio, i.e., the higher the peripheral velocity of the photosensitive drum 3b, the lower the load torque of the motor 11. When the peripheral velocity ratio exceeds 100%, the reduction effect is further enhanced. In this way, by aiding the rotation of the developing roller 3e with the rotation of the photosensitive drum 3b, it is possible to reduce the load torque of the motor 11.

When, in order to aid the rotation of the developing roller 3e, the peripheral velocity of the photosensitive drum 3b is made higher than that at the time of image formation, the load torque of the motor 11 is reduced, whereas the load torque of the motor 12 increases accordingly. However, the torque spec of the motor 12 driving the photosensitive drum 3b is selected to be adaptable to the last stage of the service life of the process cartridge 3. Accordingly, when the process cartridge is new, there is an adequate margin for torque spec, which can be utilized.

The reason for selecting the torque spec of the motor 12 to be adaptable to the last stage of the service life of the process cartridge 3 is that as the accumulated rotational time of the photosensitive drum 3b increases, the influence of each process (particularly, the influence of the wear and flaws of the photosensitive drum caused by rubbing with the cleaning blade is considered to be significant) is accumulated on the surface of the photosensitive drum, and that the torque used for rotating the photosensitive drum 3b tends to increase. Accordingly, when unsealing the seal member, the load torque of the motor 11 can be reduced by utilizing the spec margin of the motor 12, whereby it is possible to suppress a spec increase of the motor 11 caused by the load torque for unsealing the seal member, with a simple construction. Further, when Vb′>Ve, it is possible to reduce the load torque of the motor 11 more effectively.

As described above, during the period in which the seal member 3s is unsealed by the take-up member 3v, the photosensitive drum 3b is driven at a peripheral velocity higher than that during image formation. Therefore, when use of the process cartridge 3 starts, it is possible to unseal the seal member 3s with a simple construction while suppressing an increase in the waiting time for the user.

While the claimed invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-188961 filed Aug. 31, 2011, which is hereby incorporated by reference herein in its entirety.

What is claimed is:

1. An image forming apparatus comprising:
a process cartridge including an image bearing member bearing an electrostatic latent image, a toner container for storing toner, a developer carrying member configured to rotate while in contact with the image bearing member to develop the electrostatic latent image with the toner, a sealing member configured to seal an opening provided in the toner container, and an unsealing mechanism for opening the sealing member;
a first drive device configured to drive the developer carrying member and the unsealing mechanism;
a second drive device configured to drive the image bearing member; and
a control unit configured to control the first drive device and the second drive device and to drive the image bearing member by the second drive device at a peripheral velocity which is higher than that at a time of image formation, during a period of opening the sealing member by the unsealing mechanism.

2. The image forming apparatus according to claim 1, wherein, during the period of opening the sealing member, the image bearing member is driven at a peripheral velocity higher than that of the developer carrying member.

3. The image forming apparatus according to claim 2, wherein, during image formation, the developer carrying member is driven at a peripheral velocity higher than that of the image bearing member.

4. The image forming apparatus according to claim 1, further comprising a detection device configured to detect whether the process cartridge is new,
wherein the control unit causes the unsealing mechanism to open the sealing member when it is detected by the detection device that the process cartridge is new.

5. The image forming apparatus according to claim 1, wherein there is provided a plurality of the process cartridges in order to form a color image, and
wherein, during the period of opening the sealing member, with respect to the plurality of process cartridges, the control unit drives the image bearing member by the second drive device at a peripheral velocity higher than that at the time of image formation.

6. An image forming apparatus comprising:
a process cartridge including an image bearing member bearing an electrostatic latent image, a toner container for storing toner, a developer carrying member configured to rotate while in contact with the image bearing member to develop the electrostatic latent image with the toner, a sealing member configured to seal an opening provided in the toner container, and an unsealing mechanism for opening the sealing member;
a first drive device configured to drive the developer carrying member and the unsealing mechanism;
a second drive device configured to drive the image bearing member; and
a control unit configured to control the first drive device and the second drive device and to drive the image bearing member by the second drive device at a peripheral velocity which is higher than that of the developer carrying member, during a period of opening the sealing member by the unsealing mechanism.

7. The image forming apparatus according to claim 6, wherein, during image formation, the developer carrying member is driven at a peripheral velocity higher than that of the image bearing member.

8. The image forming apparatus according to claim 6, further comprising a detection device configured to detect whether the process cartridge is new,
wherein the control unit causes the unsealing mechanism to open the sealing member when it is detected by the detection device that the process cartridge is new.

9. The image forming apparatus according to claim 6, wherein there is provided a plurality of the process cartridges in order to form a color image, and
wherein, during the period of opening the sealing member, with respect to the plurality of process cartridges, the control unit drives the image bearing member by the second drive device at a peripheral velocity higher than that at a time of image formation.

10. An image forming apparatus comprising:
a detachable process cartridge including an image bearing member bearing an electrostatic latent image, a toner container for storing toner, a developer carrying member configured to rotate while in contact with the image bearing member to develop the electrostatic latent image with the toner, a sealing member configured to seal an opening provided in the toner container, and an unsealing mechanism for opening the sealing member;
a first drive device configured to drive the developer carrying member and the unsealing mechanism;
a second drive device configured to drive the image bearing member; and
a control unit configured to control the first drive device and the second drive device and to drive the image bearing member by the second drive device at a peripheral velocity which is higher than that at a time of image formation, during a period of opening the sealing member by the unsealing mechanism.

11. The image forming apparatus according to claim 10, wherein, during the period of opening the sealing member, the image bearing member is driven at a peripheral velocity higher than that of the developer carrying member.

12. The image forming apparatus according to claim 11, wherein, during image formation, the developer carrying member is driven at a peripheral velocity higher than that of the image bearing member.

13. The image forming apparatus according to claim 10, further comprising a detection device configured to detect whether the process cartridge is new,
wherein the control unit causes the unsealing mechanism to open the sealing member when it is detected by the detection device that the process cartridge is new.

14. The image forming apparatus according to claim 10, wherein there is provided a plurality of the process cartridges in order to form a color image, and
wherein, during the period of opening the sealing member, with respect to the plurality of process cartridges, the control unit drives the image bearing member by the second drive device at a peripheral velocity higher than that at the time of image formation.

15. An image forming apparatus comprising:
a detachable process cartridge including an image bearing member bearing an electrostatic latent image, a toner container for storing toner, a developer carrying member configured to rotate while in contact with the image bearing member to develop the electrostatic latent image with the toner, a sealing member configured to seal an opening provided in the toner container, and an unsealing mechanism for opening the sealing member;
a first drive device configured to drive the developer carrying member and the unsealing mechanism;
a second drive device configured to drive the image bearing member; and
a control unit configured to control the first drive device and the second drive device and to drive the image bearing member by the second drive device at a peripheral velocity which is higher than that of the developer carrying member, during a period of opening the sealing member by the unsealing mechanism.

16. The image forming apparatus according to claim 15, wherein, during image formation, the developer carrying member is driven at a peripheral velocity higher than that of the image bearing member.

17. The image forming apparatus according to claim 15, further comprising a detection device configured to detect whether the process cartridge is new,
wherein the control unit causes the unsealing mechanism to open the sealing member when it is detected by the detection device that the process cartridge is new.

18. The image forming apparatus according to claim 15, wherein there is provided a plurality of the process cartridges in order to form a color image, and
wherein, during the period of opening the sealing member, with respect to the plurality of process cartridges, the control unit drives the image bearing member by the second drive device at a peripheral velocity higher than that at a time of image formation.
